(19) United States
(12) Patent Application Publication
(10) Pub. No.: US 2012/0061237 A1
(43) Pub. Date: Mar. 15, 2012

(54) CATHODE FOR ELECTROLYTIC PROCESSES

(75) Inventors: Marianna Brichese, Caorle (VE) (IT); Antonio Lorenzo Antozzi, Merate (LC) (IT); Alice Calderara, Agnadello (CR) (IT)

(73) Assignee: Industrie De Nora S.p.A., Milan (IT)

(21) Appl. No.: 13/298,630

(22) Filed: Nov. 17, 2011

(30) Foreign Application Priority Data
May 19, 2009 (IT) MI2009A000880
May 18, 2010 (EP) PCT/EP2010/056797

(51) Int. Cl. C25B 11/06; B05D 1/36; B05D 1/18; C25B 11/08; B05D 5/12

(52) U.S. Cl. 204/290.08; 204/290.03; 427/123

(57) ABSTRACT

The invention relates to a cathode for electrolytic processes with evolution of hydrogen comprising a metal substrate with a noble metal-based activation layer and two protective layers, one interposed between the activation layer and the substrate and one external, containing an electroless-depositable alloy of a metal comprising one of nickel, cobalt and iron with a non-metal selected from phosphorus and boron, with the optional addition of a transition element selected between tungsten and rhenium.

### CROSS-REFERENCE TO RELATED APPLICATION

This application is a continuation of PCT/EP2010/056797 filed May 18, 2010, that claims the benefit of the priority date of Italian Patent Application No. MI2009000880 filed May 19, 2009, the contents of which are herein incorporated by reference in their entirety.

### FIELD OF THE INVENTION

The invention relates to an electrode suitable for acting as cathode in electrolytic cells, for instance as hydrogen-evolving cathode in chlor-alkali cells.

### BACKGROUND OF THE INVENTION

The invention relates to an electrode for electrolytic processes, in particular to a cathode suitable for hydrogen evolution in an industrial electrolysis process. Reference will be made hereafter to chlor-alkali electrolysis as a typical industrial electrolytic process with cathodic evolution of hydrogen, but the invention is not limited to a particular application. In the electrolytic process industry, competitiveness is associated with several factors, the main one being the reduction of energy consumption, directly linked to the electrical operating voltage. Among the various components which contribute to determining the operating voltage, besides factors associated with ohmic drop and mass transport, the overvoltages of the evolution reactions of the two products, anodic and cathodic (in the case of chlor-alkali electrolysis, anodic chlorine evolution overvoltage and cathodic hydrogen evolution overvoltage) are of high relevance. In the industrial practice, such overvoltages are minimised through the use of suitable catalysts. The use of cathodes consisting of metal substrates, for instance of nickel, copper or steel, provided with catalytic coatings based on oxides of ruthenium, platinum or other noble metals is known in the art. For instance, there has been disclosed nickel cathodes provided with a coating based on ruthenium oxide mixed with nickel oxide, capable of lowering the cathodic hydrogen evolution overvoltage. Also other types of catalytic coating for metal substrates suitable for catalysing hydrogen evolution are known, for instance based on platinum, on rhenium or molybdenum optionally alloyed with nickel, on molybdenum oxide. The majority of these formulations nevertheless show a rather limited operative lifetime in common industrial applications, probably due to the poor adhesion of the coating to the substrate.

A certain increase in the useful lifetime of cathodes activated with noble metal at the usual process conditions is obtainable by depositing an external layer on top of the catalytic layer, consisting of an alloy of nickel, cobalt or iron with phosphorus, boron or sulphur, for example by means of an electroless procedure, has also been disclosed in the prior art.

Such finding, however, leaves unsolved the problem of tolerance to current reversals which sometimes may take place in the electrolysers, almost always due to unexpected malfunctioning, for instance during maintenance operations. In such a situation, the anchoring of the catalytic coating to the substrate is more or less seriously compromised, part of the active component being liable to detachments from the cathode substrate with consequent decrease of the catalytic efficiency and increase of the operating voltage. This phenomenon is particularly relevant in the case of cathodes containing ruthenium dioxide, which are vastly applied in industrial processes due to their excellent catalytic activity. A measure of such quick loss of activity can be detected, as it will be clear to a person of skill in the art, by subjecting electrode samples to cyclic voltammetry within a range of potential between hydrogen cathodic discharge and oxygen anodic one. An electrode potential decay in the range of tens of millivolts is almost always detectable since the very first cycles. This poor resistance to inversions constitutes an unsolved problem for the main types of activated cathode for electrolytic applications and especially for cathodes based on ruthenium oxide optionally in admixture with nickel oxide commonly employed in chlor-alkali electrolysis processes.

### SUMMARY OF THE INVENTION

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter. As provided herein, the invention comprises, under one aspect a cathode suitable for hydrogen evolution in electrolytic processes comprising a conductive substrate coated with a first intermediate protective layer, a catalytic layer and a second external protective layer, the first and second protective layer comprising an alloy consisting of at least one metal selected between nickel, cobalt and chromium, at least one non-metal selected between phosphorus and boron and optionally a transition element selected between tungsten and rhenium.

In another aspect the invention comprises a method for manufacturing a cathode, comprising electrolessly depositiing a first protective layer by contacting a conductive substrate with at least one first solution, gel or ionic liquid containing the precursors of an alloy comprising at least one metal selected between nickel, cobalt and chromium, at least one non-metal selected between phosphorus and boron and optionally a transition element selected between tungsten and rhenium, applying a catalytic layer by thermal decomposition of at least one catalyst precursor solution in one or more cycles, and electrolessly depositing a second protective layer by contacting the conductive substrate provided with a catalytic layer with at least one second solution, gel or ionic liquid containing the precursors of the alloy.

To the accomplishment of the foregoing and related ends, the following description sets forth certain illustrative aspects and implementations. These are indicative of but a few of the various ways in which one or more aspects may be employed. Other aspects, advantages, and novel features of the disclosure will become apparent from the following detailed description.

### DESCRIPTION

Several aspects of the invention are set forth in the appended claims.

In one embodiment, the invention relates to an electrode suitable for functioning as a cathode in electrolytic processes comprising a conductive substrate sequentially coated with a first protective intermediate layer, a catalytic layer and a second external protective layer, the first and the second protective layers comprising an alloy consisting of one or more metals selected between nickel, cobalt and chromium and one or more non-metals selected between phosphorus and boron. The alloy of the protective layers may additionally contain a transition element, for instance selected between tungsten and rhenium. In one embodiment, the catalytic layer contains oxides of non-noble transition metals, for instance rhenium or molybdenum. In one embodiment, the catalytic layer contains platinum group metals and oxides or compounds thereof, for instance ruthenium dioxide. The experimental tests showed that the deposition of compact and coherent layers of the above defined alloys externally to the catalytic layer and at the same time between catalytic layer and substrate favours the catalyst anchoring to a surprising extent, without the additional ohmic drop significantly affecting the electrode potential.

In one embodiment, at least one of the two protective layers comprises an alloy which can be deposited by autocatalytic chemical reduction according to the process known to those skilled in the art as “electroless”. This type of manufacturing procedure can have the advantage of being easily applicable to substrates of various geometries such as solid, perforated or expanded sheets, as well as meshes, optionally of very reduced thickness, without having to introduce substantial changes to the manufacturing process as a function of the various geometries and sizes, as would happen in the case of a galvanic deposition. The electroless deposition is suited to substrates of several kinds of metals used in the production of cathodes, for instance nickel, copper, zirconium and various types of steels such as stainless steels.

In one embodiment, the alloy which can be deposited via an electroless process is an alloy of nickel and phosphorous in a variable ratio, generally indicated as Ni—P.

In one embodiment, the specific loading of the first protective layer, that is the interlayer directly contacting the metal substrate, is lower, for instance being about one half, the specific loading of the second outermost protective layer. In one embodiment, the specific loading of the interlayer is 5-15 g/m² than the specific loading of the external protective layer is 10-30 g/m². The above specified loadings are sufficient to obtain macroscopically compact and coherent layers conferring a proper anchoring of the catalytic layer to the base and a protection from the aggressive action of the electrolyte, without hampering the mass transport of the same electrolyte to the catalytic sites and the release of hydrogen evolved by the cathodic reaction.

In one embodiment, a method for the preparation of a cathode as described comprises a step of deposition of the protective interlayer via an electroless process putting the substrate in contact for a sufficient time with a solution, gel or ionic liquid or sequentially with more solutions, gels or ionic liquids containing the precursors of the selected alloy; a subsequent step of deposition of the catalytic layer by application of a precursor solution of the catalytic components in one or more cycles with thermal decomposition after each cycle; and a subsequent step of deposition of the external protective layer via electroless, analogous to the interlayer deposition step.

In one embodiment, a layer of nickel-phosphorous alloy can be deposited as the protective interlayer or external layer by sequential dipping in a first solution containing 0.1-5 g of PdCl₂ in acidic environment for 10-300 s; a second solution containing 10-100 g/l of NaH₂PO₂ for 10-300 s; a third solution containing 5-50 g/l of NaH₂PO₂ and optionally NiSO₄, (NH₄)₂SO₄ and Na₃C₃H₅O(CO₂)₃ in a basic environment of ammonia for 30 minutes-4 hours.

In one embodiment, the catalyst precursor solution contains Ru(NO)ₓ(NO₃)₂ or RuCl₃.

Some of the most significant results obtained by the inventors are presented in the following examples, which are not intended as a limitation of the extent of the invention.

### EXAMPLE 1

A nickel mesh of 100 mm×100 mm×1 mm size was sandblasted, etched in HCl and degreased with acetone according to a standard procedure, then subjected to an electroless deposition treatment by sequential dipping in three aqueous solutions having the following composition:
Solution A: 1 g/l PdCl₂+4 ml/l HCl
Solution B: 50 g/l NaH₂PO₂
Solution C: 20 g/l NiSO₄+30 g/l (NH₄)₂SO₄+30 g/l NaH₂PO₂+10 g/l Na₃C₃H₅O(CO₂)₃(trisodium citrate)+10 ml/l ammonia.

The mesh was sequentially dipped for 60 seconds in solution A, seconds in solution B and 2 hours in solution C.

At the end of the treatment, a superficial deposition of about 10 g/m² of Ni—P alloy was observed.

The same mesh was subsequently activated with a RuO₂ coating consisting of two layers, the former deposited in a single coat by application of RuCl₃ dissolved in a mixture of aqueous HCl and 2-propanol, followed by thermal decomposition, the latter deposited in two coats by application of RuCl₃ dissolved in 2-propanol, with subsequent thermal decomposition after each coat. The thermal decomposition steps were carried out in a forced ventilation oven with a thermal cycle of 10 minutes at 70-80° C. and 10 minutes at 500° C. In this way, 9 g/m² of Ru expressed as metal were deposited.

The thus activated mesh was again subjected to an electroless deposition treatment by dipping in the three above indicated solutions, until obtaining the deposition of an external protective layer consisting of about 20 g/m² of Ni—P alloy.

Three samples of 1 cm² cut out from the activated mesh showed a starting IR-corrected average cathodic potential of −930 mV/NHE at 3 kA/m² under hydrogen evolution in 33% NaOH, at a temperature of 90° C., which indicates an excellent catalytic activity. The same samples were subsequently subjected to cyclic voltammetry in the range of −1 to +0.5 V/NHE with a 10 mV/s scan rate; the average cathodic potential shift after 25 cycles was 35 mV, indicating an excellent current reversal tolerance.

From the same activated mesh, 3 samples of 2 cm² surface were also cut out to be subjected to an accelerated life-test under cathodic hydrogen evolution at exasperated process conditions, utilising 33% NaOH at 90° C. as the electrolyte and setting a current density of 10 kA/m². The test consists of periodically detecting the cathodic potential, following its evolution over time and recording the deactivation time. The latter is defined as time required to reach a potential increase of 100 mV with respect to the starting value. The average deactivation time of the three samples was 3670 hours.

### EXAMPLE 2

A nickel mesh of 100 mm×100 mm×1 mm size was sandblasted, etched in HCl and degreased with acetone according to a standard procedure, then subjected to an electroless deposition treatment by dipping for 1 hour in an aqueous solution having the following composition: 35 g/l NiSO₄+20 g/l MgSO₄+10 g/l NaH₂PO₂+10 g/l Na₃C₃H₅O(CO₂)₃+10 g/l CH₃COONa.

At the end of the treatment, a superficial deposition of about 8 g/m² of Ni—P alloy was observed.

The same mesh was subsequently activated with a RuO₂ coating consisting of two layers, the former deposited in a single coat by application of RuCl₃ dissolved in a mixture of aqueous HCl and 2-propanol, followed by thermal decomposition, the latter deposited in two coats by application of RuCl₃ dissolved in 2-propanol, with subsequent thermal decomposition after each coat. The thermal decomposition steps were carried out in a forced ventilation oven with a thermal cycle of 10 minutes at 70-80° C. and 10 minutes at 500° C. In this way, 9 g/m² of Ru expressed as metal were deposited.

The thus activated mesh was again subjected to an electroless deposition treatment by dipping in the above indicated solution, until obtaining the deposition of an external protective layer consisting of about 25 g/m² of Ni—P alloy.

Three samples of 1 cm² cut out from the activated mesh showed a starting IR-corrected average cathodic potential of −935 mV/NHE at 3 kA/m² under hydrogen evolution in 33% NaOH, at a temperature of 90° C. The same samples were subsequently subjected to cyclic voltammetry in the range of −1 to +0.5 V/NHE with a 10 mV/s scan rate; the average cathodic potential shift after 25 cycles was 35 mV, indicating an excellent current reversal tolerance.

From the same activated mesh, 3 samples of 2 cm² surface were also cut out to be subjected to the same accelerated life-test described in example 1. The average deactivation time of the three samples was 3325 hours.

### EXAMPLE 3

Example 1 was repeated on a nickel mesh of 100 mm×100 mm×0.16 mm size after adding a small amount of a thickener (xanthan gum) to solutions A and B, and of the same component to a solution equivalent to C but with all solutes in a threefold concentration. Brush-applicable homogeneous gels were obtained in the three cases. The three gels were sequentially applied to the nickel mesh, until obtaining a superficial deposition of about 5 g/m² of Ni—P alloy.

The same mesh was subsequently activated with a RuO₂ coating consisting of two layers, the former deposited in a single coat by application of RuCl₃ dissolved in a mixture of aqueous HCl and 2-propanol, followed by thermal decomposition, the latter deposited in two coats by application of RuCl₃ dissolved in 2-propanol, with subsequent thermal decomposition after each coat. The thermal decomposition steps were carried out in a forced ventilation oven with a thermal cycle of 10 minutes at 70-80° C. and 10 minutes at 500° C. In this way, 9 g/m² of Ru expressed as metal were deposited.

The three above gels were again sequentially applied to the thus activated mesh, until obtaining the superficial deposition of about 10 g/m² of Ni—P alloy.

Three samples of 1 cm² cut out from the activated mesh showed a starting IR-corrected average cathodic potential of −936 mV/NHE at 3 kA/m² under hydrogen evolution in 33% NaOH, at a temperature of 90° C. The same samples were subsequently subjected to cyclic voltammetry in the range of −1 to +0.5 V/NHE with a 10 mV/s scan rate; the average cathodic potential shift after 25 cycles was 38 mV, indicating an excellent current reversal tolerance.

From the same activated mesh, 3 samples of 2 cm² surface were also cut out to be subjected to the same accelerated life-test described in example 1. The average deactivation time of the samples was 3140 hours.

### COMPARATIVE EXAMPLE 1

A nickel mesh of 100 mm×100 mm×1 mm size was sandblasted, etched in HCl and degreased with acetone according to a standard procedure, then directly activated without applying any protective interlayer with a RuO₂ coating consisting of two layers with a total loading of 9 g/m² of Ru expressed as metal, according to the previous examples.

Three samples of 1 cm² cut out from the activated mesh showed a starting IR-corrected average cathodic potential of −928 mV/NHE at 3 kA/m² under hydrogen evolution in 33% NaOH, at a temperature of 90° C. The same samples were subsequently subjected to cyclic voltammetry in the range of −1 to +0.5 V/NHE with a 10 mV/s scan rate; the average cathodic potential shift after 25 cycles was 160 mV, indicating a non-optimum current reversal tolerance.

From the same activated mesh, 3 samples of 2 cm² surface were also cut out to be subjected to the same accelerated life-test described in example 1. The average deactivation time of the samples was 2092 hours.

COMPARATIVE EXAMPLE 2

A nickel mesh of 100 mm×100 mm×1 mm size was sandblasted, etched in HCl and degreased with acetone according to a standard procedure, then directly activated without applying any protective interlayer with a RuO₂ coating consisting of two layers with a total loading of 9 g/m² of Ru expressed as metal, according to the previous examples.

The thus activated mesh was subjected to an electroless deposition treatment by dipping in the three solutions of Example 1, until obtaining the superficial deposition of an outer protective layer consisting of about 30 g/m² of Ni—P alloy.

Three samples of 1 cm² cut out from the activated mesh showed a starting IR-corrected average cathodic potential of −927 mV/NHE at 3 kA/m² under hydrogen evolution in 33% NaOH, at a temperature of 90° C. The same samples were subsequently subjected to cyclic voltammetry in the range of −1 to +0.5 V/NHE with a 10 mV/s scan rate; the average cathodic potential shift after 25 cycles was 60 mV, indicating a non-optimum current reversal tolerance.

From the same activated mesh, 3 samples of 2 cm² surface were also cut out to be subjected to the same accelerated life-test described in example 1. The average deactivation time of the samples was 2760 hours.

The previous description is not intended to limit the invention, which may be used according to different embodiments without departing from the scopes thereof, and whose extent is univocally defined by the appended claims.

Throughout the description and claims of the present application, the term “comprise” and variations thereof such as “comprising” and “comprises” are not intended to exclude the presence of other elements or additives.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention before the priority date of each claim of this application.

What we claim is:

1. Cathode suitable for hydrogen evolution in electrolytic processes comprising a conductive substrate coated with a first intermediate protective layer, a catalytic layer and a second external protective layer, said first and second protective layer comprising an alloy comprising at least one metal selected between nickel, cobalt and chromium, at least one non-metal selected between phosphorus and boron and optionally a transition element selected between tungsten and rhenium.

2. The cathode according to claim 1 wherein the catalytic layer comprises at least one element selected from the group consisting of molybdenum, rhenium and platinum group metals.

3. The cathode according to claim 2 wherein the catalytic layer contains RuO₂.

4. The cathode according to claim 1 wherein at least one of the first and the second protective layer comprises an alloy of nickel and phosphorus.

5. The cathode according to claim 1, wherein the conductive substrate comprising a solid, punched on expanded sheet or a mesh made of nickel, copper, zirconium or stainless steel.

6. The cathode according to claim 1, wherein the first protective layer has a specific loading of 5-15 g/m² and the second protective layer has a specific loading of 10-30 g/m².

7. Method for manufacturing a cathode, comprising:
a) electrolessly depositiing a first protective layer by contacting a conductive substrate with at least one first solution, gel or ionic liquid containing the precursors of an alloy comprising at least one metal selected between nickel, cobalt and chromium, at least one non-metal selected between phosphorus and boron and optionally a transition element selected between tungsten and rhenium;
b) applying a catalytic layer by thermal decomposition of at least one catalyst precursor solution in one or more cycles; and
c) electrolessly depositing a second protective layer by contacting the conductive substrate provided with a catalytic layer with at least one second solution, gel or ionic liquid containing the precursors of the alloy.

8. The method according to claim 7, wherein at least one of said at least one first and said at least one second solution containing the precursors of said alloy contains NaH₂PO₂.

9. The method according to claim 7, wherein the deposition of the first and/or of the second protective layer is carried out by sequential dipping in:
a) a first solution containing 0.1-5 g of PdCl₂ in acidic environment for 10-300 s;
b) a second solution containing 10-100 g/l of NaH₂PO₂ for 10-300 s;
c) a third solution containing 5-50 g/l of NaH₂PO₂ and optionally NiSO₄, (NH₄)₂SO₄ and Na₃C₃H_{S}O(CO₂)₃ made alkaline by ammonia for 0.5-4 hours.

10. The method according to claim 7, wherein the at least one catalyst precursor solution contains Ru(NO)ₓ(NO₃)₂ or RuCl₃.
